(19) United States
(12) Patent Application Publication
(10) Pub. No.: US 2012/0216464 A1
(43) Pub. Date: Aug. 30, 2012

(54) DEVICE FOR PROTECTING DOOR OR WINDOW CLOSURE ELEMENTS FOR ROOFS OR THE LIKE AGAINST ATMOSPHERIC PRECIPITATION

(76) Inventor: Stefano Bonapace, Pinzolo (IT)

(21) Appl. No.: 13/509,357

(22) PCT Filed: Nov. 11, 2010
(86) PCT No.: PCT/EP2010/067319

§ 371 Date: May 11, 2012

(30) Foreign Application Priority Data
Nov. 12, 2009 (IT) VR2009A000187
Jun. 1, 2010 (IT) VR2010A000118

(51) Int. Cl. E06B 9/00; E06B 9/52; E06B 7/00

(52) U.S. Cl. 52/173.1; 52/202

(57) ABSTRACT

A device for protecting door or window closure elements for roofs or the like against atmospheric precipitation has at least one covering element, which can be connected to the structure of a building by virtue of connection elements. The covering element can be arranged in at least one position for use, in which, at least partially, it is arranged above and faces at least one door or window closure element that is defined substantially parallel to a portion of the cover of the building.

### TECHNICAL FIELD

The present invention relates to a device for protecting door or window closure elements for roofs or the like against atmospheric precipitation.

### BACKGROUND ART

It is known that the roofs of some buildings are provided with door or window closure elements which are constituted by windows, which allow the lighting and ventilation of rooms provided in the attic, or by trapdoors, which allow access to the roof from the inside of the building.

These door or window closure elements are arranged, in some cases, parallel to the slopes of the roof, with the consequence of being particularly exposed to atmospheric precipitation, such as snow or hailstones.

In particular, in the event of heavy snowfall, roof windows of this type are completely covered by snow and therefore it is impractical to open them and the passage of light through them is prevented.

A similar problem affects trapdoors which are provided for access to the roof, which in the presence of heavy snowfall become inaccessible, thus preventing the possibility of reaching the roof from the inside of the building in order to shovel the snow off the roof.

Another problem of roof door or window closure elements is that they can be damaged easily by hailstones.

### DISCLOSURE OF THE INVENTION

The aim of the present invention is to provide a solution to the above mentioned drawbacks, by providing a device for protecting windows or access trapdoors for roofs or the like against atmospheric precipitation, which is capable of effectively sheltering the door or window closure elements arranged in the roof against snow and hailstones.

Within this aim, an object of the invention is to provide a device for protecting door or window closure elements for roofs or the like against atmospheric precipitation that makes their opening possible even in the event of heavy snowfall.

Another object of the present invention is to provide a device for protecting door or window closure elements for roofs or the like against atmospheric precipitation that allows the continuous entry of sunlight through the windows of the roof, even in the presence of abundant snow.

Another object of the invention is to provide a device for protecting door or window closure elements for roofs or the like against atmospheric precipitation that can be applied easily to the roofs of existing buildings.

Another object of the present invention is to provide a device for protecting door or window closure elements for roofs or the like against atmospheric precipitation that can be effectively anchored to the roof of buildings with the possibility of performing a continuous adjustment of its position with respect to the door or window closure elements to be protected.

Another object of the invention is to provide a device for protecting door or window closure elements for roofs or the like against atmospheric precipitation that is capable of offering the greatest assurances of reliability and safety during its operation.

Another object of the present invention is to provide a device for protecting door or window closure elements for roofs or the like against atmospheric precipitation that has a very simple structure and is low cost.

This aim, as well as these and other objects which will become better apparent hereinafter, are achieved by a device for protecting door or window closure elements for roofs or the like against atmospheric precipitation, according to the invention, which is characterized in that it comprises at least one covering element which can be connected to the structure of a building by virtue of connection means and can be arranged in at least one position for use, in which, at least partially, it is arranged above and faces a door or window closure element that is defined substantially parallel to a portion of the cover of the building.

### BRIEF DESCRIPTION OF THE DRAWINGS

Further characteristics and advantages of the invention will become better apparent from the following detailed description of some preferred but not exclusive embodiments of the device according to the invention, illustrated by way of non-limiting example in the accompanying drawings, wherein:

FIG. 1 is a perspective view of a first embodiment of the device according to the invention;

FIG. 2 is a perspective view of a second embodiment of the device according to the invention;

FIG. 3 is a perspective view of a third embodiment of the device according to the invention;

FIG. 4 is a perspective view of an embodiment of the device according to the invention with extension elements applied thereto;

FIG. 5 is a perspective view of a different embodiment of the device according to the invention;

FIG. 6 is a perspective view of a further embodiment of the device according to the invention;

FIG. 7 is a perspective view of a possible further embodiment of the device according to the invention;

FIG. 8 is a perspective view of another embodiment of the device according to the invention;

FIG. 9 is a perspective view of another embodiment of the device according to the invention;

FIG. 10 is a perspective view of a further embodiment of the device according to the invention;

FIG. 11 is a partial perspective view of the anchoring means of the device according to the invention;

FIG. 12 is a perspective view of another embodiment of the connection means of the device according to the invention, which allow a continuous adjustment of the position of the covering element;

FIG. 13 is another perspective view of the embodiment of FIG. 12;

FIG. 14 is a front elevation view of the embodiment of FIG. 12;

FIG. 15 is a side elevation view of the embodiment of FIG. 12;

FIG. 16 is a plan view of the embodiment of FIG. 12;

FIG. 17 is a perspective view of a detail of the embodiment of the connection means of FIG. 12 applied to a roof;

FIG. 18 is a view of another detail of the connection means in the embodiment of FIG. 12;

FIG. 19 is a view of a possible embodiment of the connection between two plate-like protection elements that constitute the covering element;

FIG. 20 is a perspective view of a linking element which can be associated with the plate-like protection element;

FIG. 21 is a perspective view, taken from a different angle, of the linking element of FIG. 20;

FIG. 22 is a perspective view of another embodiment of the linking element which can be associated with a plate-like protection element made of sheet metal;

FIG. 23 is a front elevation view of the embodiment of FIG. 22;

FIG. 24 is a side elevation view of the linking element of FIG. 22;

FIG. 25 is a view of the linking element of FIG. 22 applied to a plate-like protection element;

FIG. 26 is another perspective view of the application of FIG. 25;

FIG. 27 is an perspective view, taken from above, of the device according to the invention with an insect- and/or pollen-blocking sheet applied;

FIG. 28 is a perspective view of a different embodiment of the device according to the invention with an insect- and/or pollen-blocking sheet applied.

### WAYS OF CARRYING OUT THE INVENTION

With reference to the figures, a device for protecting door or window closure elements for roofs or the like against atmospheric precipitation, according to the invention, generally indicated with the reference numeral I, comprises at least one covering element 2, which can be connected to the structure of a building by virtue of connection means 3.

Also according to the invention, the covering element 2 can be arranged in at least one position for use, in which, in an upper region, it at least partially faces toward at least one door or window closure element 4, which is defined, at least with the corresponding seat, substantially parallel to a portion of the cover of the building, which is constituted for example by a slope 5 of the roof 6 of the building.

In particular, the door or window closure element 4 can be constituted, for example, by a window or skylight or, as an alternative, by an access trapdoor or any other opening provided in the roof 6 of the building.

In practice, in the position for use, the covering element 2 makes it possible to protect the windows or access trapdoors arranged on the roof 6 of the building against atmospheric precipitation, thus avoiding the damage caused by hailstones and preventing the possibility of the accumulation of snow directly on the windows or on the access trapdoors of the roof 6.

Conveniently, in its position for use, the covering element 2 is at least partially distanced upward from the door or window closure element 4, so as to ensure the possibility of opening the door or window closure element 4 even in the presence of a considerable layer of snow on the roof 6, thus allowing the passage of air from the outside to the inside of the building through the door or window closure element 4.

Optionally, the connection means 3 can comprise means for varying the height of at least one portion of the covering element 2 over the door or window closure element 4, and such means in practice makes it possible to move the covering element 2 towards or away from the door or window closure element 4, according to requirements.

In general, the covering element 2 comprises preferably at least one plate-like protection element 7, which can advantageously have at least one portion that is substantially transparent to light, so as to not obstruct the passage of light through the door or window closure element 4.

More specifically, each plate-like protection element 7 can be constituted by a panel 8, which is conveniently connected at its peripheral region to a perimetric supporting frame 9.

Conveniently, the panel 8 can be made of substantially transparent material and in this case it can be constituted by a sheet of laminated glass or by a sheet made of the plastic material known by the trade name Plexiglas.

As an alternative, the panel 8 can also be opaque, and in this case it can be provided for example by means of sheet metal.

Advantageously, in the position for use of the covering element 2, the plate-like protection element 7 can be arranged inclined with respect to the plane of arrangement of the seat of the door or window closure element 4, so as to facilitate the runoff of the atmospheric precipitation falling thereon.

Conveniently, means can also be provided for varying the inclination of the plate-like protection element 7 with respect to the plane of arrangement of the seat of the door or window closure element 4.

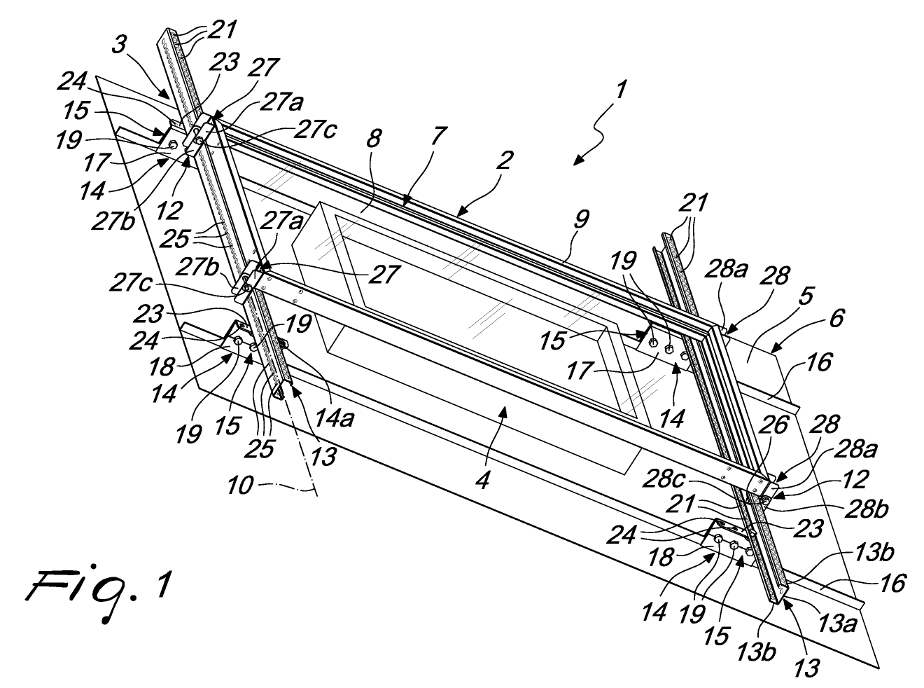

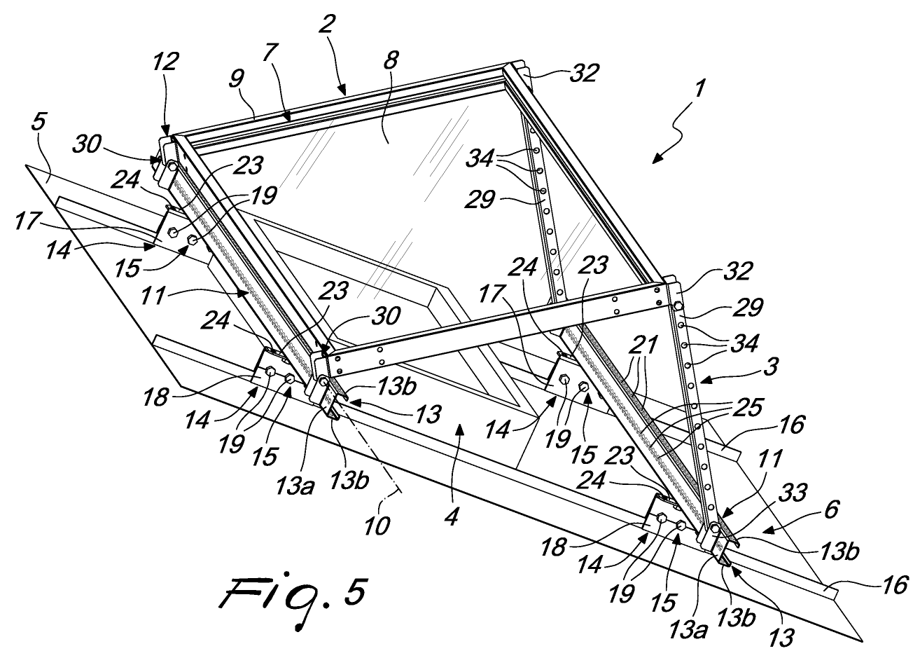

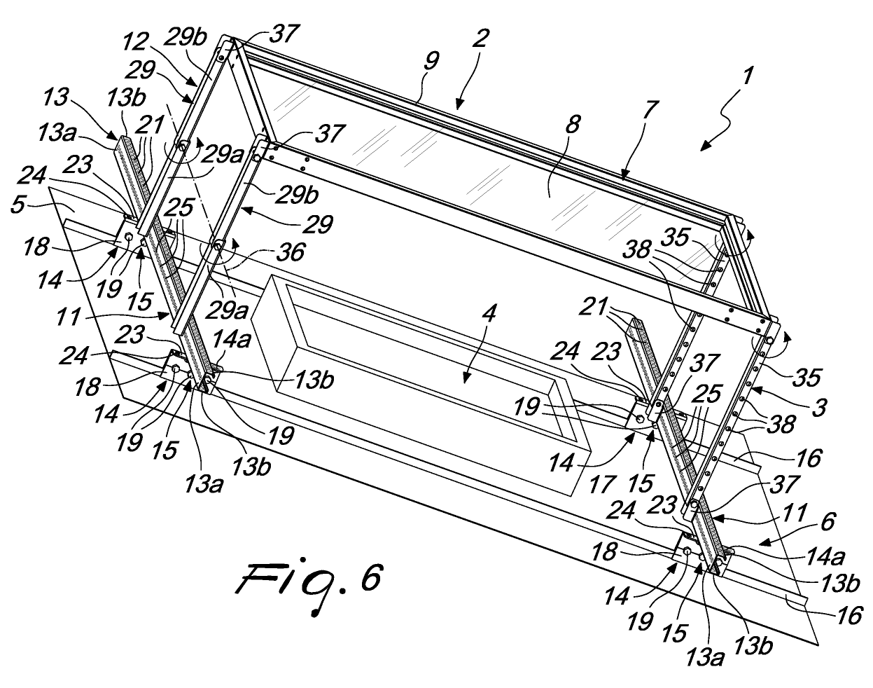

As an alternative, the plate-like protection element 7 can also be arranged, in the position for use of the covering element 2, so as to be substantially parallel to the plane of arrangement of the seat of the door or window closure element 4, as shown in particular in the examples of Figures 1 and 6.

It should be noted that optionally the covering element 2 can also comprise at least two plate-like protection elements 7 and, more specifically, at least one first plate-like protection element 7a and at least one second plate-like protection element 7b.

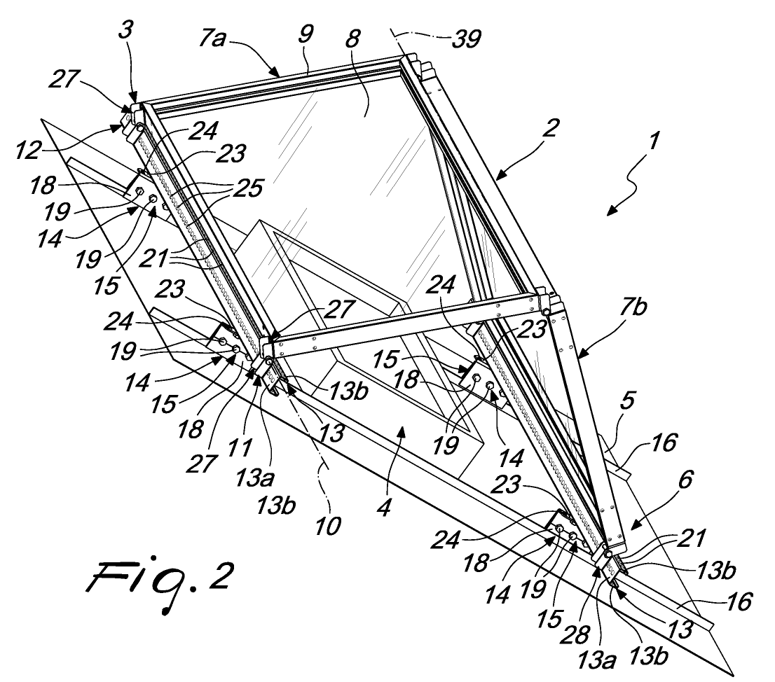

In this case, with the covering element 2 in the position for use, the first plate-like protection element 7a and the second plate-like protection element 7b can be arranged so as to be angularly spaced from each other and be inclined with respect to the plane of arrangement of the seat of the door or window closure element 4, as in the example of FIG. 2, so as to create two sloping planes for the runoff of atmospheric precipitation.

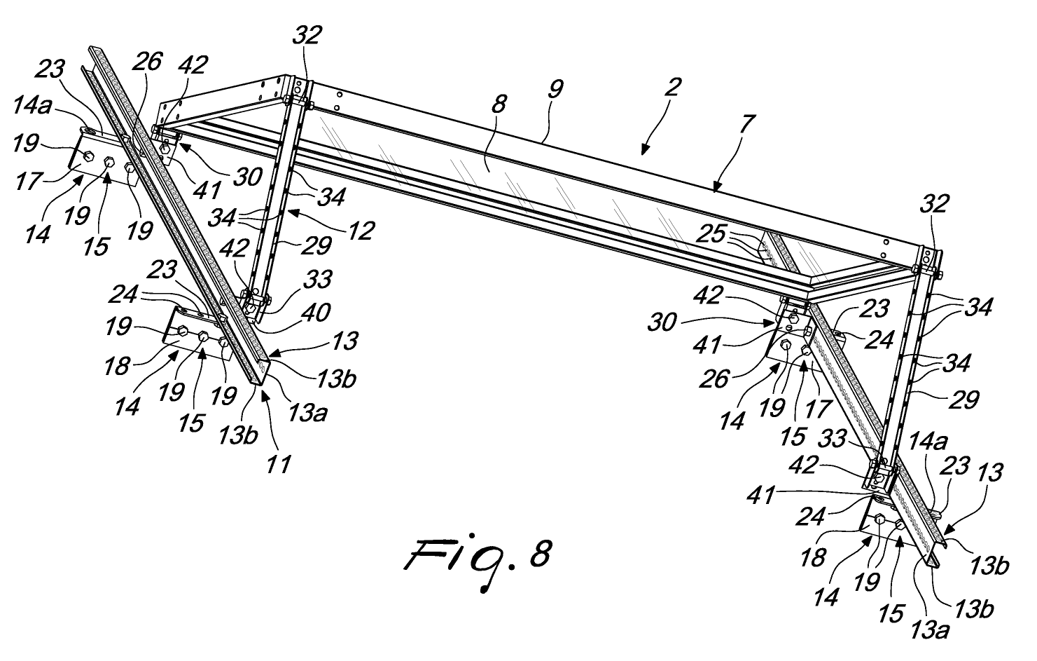

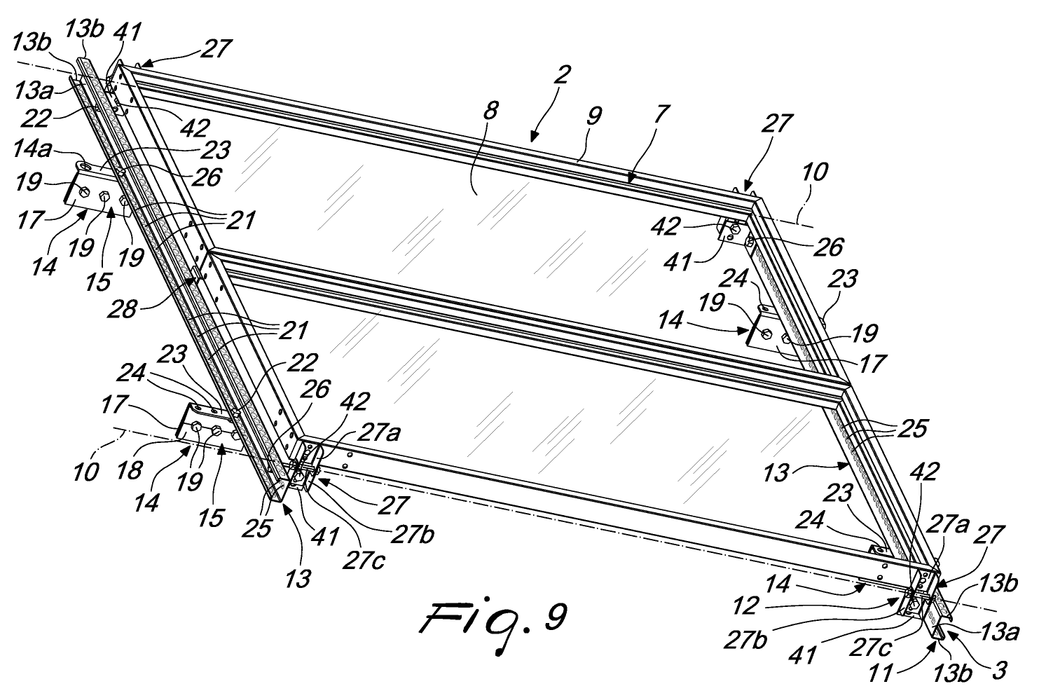

As an alternative, the first plate-like protection element 7a and the second plate-like protection element 7b can also be arranged so as to be side by side and be substantially parallel to the plane of arrangement of the seat of the door or window closure element 4, as shown in FIG. 9.

Advantageously, with the or with each plate-like protection element 7b it is furthermore possible to associate heating means, which can be activated on command in order to heat the plate-like protection element 7 in order to melt the snow or hailstones that is gradually deposited on the plate-like protection element 7, thus facilitating their removal from the plate-like protection element 7.

Such heating means can be obtained for example by means of an electric heating element, of any suitable type, which can be arranged for example within the thickness of the panel 8 of the or of each plate-like protection element 7.

Advantageously, the covering element 2 can be moved from the position for use to a non-use position, in which it is arranged laterally with respect to the door or window closure element 4, and vice versa.

It should be noted that the movement of the covering element 2 between the position for use and the non-use position can be performed manually or automatically with the aid of drive means of any suitable type.

More specifically, when the covering element 2 is in the position for use, the or each plate-like protection element 7 is in an active condition, in which it conveniently faces toward and is arranged above, with at least one portion of one of its faces, the door or window closure element 4, whereas when the covering element 2 is in the non-use position, the or each plate-like protection element 7 is arranged in an inactive condition, in which it is substantially arranged parallel to the slope 5 of the roof 6 or, in any case, to the portion of the cover of the building in which the door or window closure element 4 is defined, and laterally with respect to the door or window closure element 4.

Conveniently, the or each plate-like protection element 7 can be rotatably movable on command, with respect to the slope 5 of the roof 6, about at least one positioning axis 10, which is substantially parallel to the slope 5 of the roof 6, so as to be able to pass from its active condition to its inactive condition and vice versa.

In greater detail, the connection means 3 preferably comprise anchoring means 11, which make it possible to couple the covering element 2 to the slope 5 of the roof 6, and also interconnection means 12, which provide the connection between the or between each plate-like protection element 7 and the anchoring means 11.

Conveniently, the above mentioned anchoring means 11 comprise a pair of longitudinal supporting members 13, which are advantageously arranged on mutually opposite sides with respect to the door or window closure element 4.

For example, the longitudinal supporting members 13 can be arranged respectively in proximity to the upper end and to the lower end of the door or window closure element 4 or in proximity to the opposite lateral sides of the door or window closure element 4.

Preferably, the longitudinal supporting members 13 are each constituted by a respective metal profiled element which has, in transverse cross-section, a substantially C-shaped cross-section, in which there is a central wall 13a and a pair of lateral wings 13b, which protrude substantially at right angles from the central wall 13a and face each other.

Conveniently, the longitudinal supporting members 13 can be connected to anchoring brackets 14, which in turn can be fixed to the slope 5 of the roof 6.

Preferably, each longitudinal supporting member 13 is connected to the slope 5 of the roof 6 by means of a respective pair of anchoring brackets 14.

Specifically, each one of the anchoring brackets 14 is advantageously provided with locking means 15, which make it possible to fix the anchoring brackets 14 to a linking element which is integral with the roof 6 of the building.

In greater detail, if the roof 6 has a cover made of sheet metal, the anchoring brackets 14 can be fixed, by virtue of the locking means 15, to the seams 16 which are typically provided on the sheet metal of the roof 6.

Conveniently, the locking means 15 of each of the anchoring brackets 14 can be constituted by clamping means which are obtained for example by means of an abutment plate 17, which can be connected to a corresponding longitudinal supporting member 13, and by a locking plate 18, which can be faced toward the abutment plate 17 and can be moved toward it by virtue of bolt-type linking elements 19, so as to be able to fasten to a seam 16 of the sheet metal of the roof 6 between the abutment plate 17 and the locking plate 18.

With reference to FIG. 8, if the roof 6 is provided with a tile cover, each one of the anchoring brackets 14 can advantageously be associated with a respective stand 20, which has at least one fixing portion 20a which can be coupled, for example by bolting, to a linking region which is provided on the roof 6 of the building.

Each stand 20 is furthermore provided with a connecting wall 20b, which is designed to protrude substantially at right angles from the slope 5 of the roof 6 and can be engaged by the locking means 15 of a corresponding anchoring bracket 14. More specifically, the connecting wall 20b of the stand 20 can be fastened between the abutment plate 17 and the locking plate 18 of a respective anchoring bracket 14, so as to be able to mutually lock the stand 20 and the anchoring bracket 14.

Advantageously, the anchoring means 11 have various possibilities for adjustment, which are adapted to allow a suitable placement of the covering element 2 on the roof 6 of the building.

More specifically, the anchoring means 11 conveniently comprise means for adjusting the position of the anchoring brackets 14 along the longitudinal extension of the longitudinal supporting members 13.

It is furthermore optionally possible to also provide means for adjusting the distance between the locking means 15 of the anchoring brackets 14 and the connecting point of the anchoring brackets 14 to the longitudinal supporting members 13, and means for varying the angular orientation of the anchoring brackets 14 with respect to the longitudinal supporting members 13, so as to be able to have a wide range of possible adjustments of the position of the anchoring brackets 14 with respect to the longitudinal supporting members 13.

In particular, the means for adjusting the position of the anchoring brackets 14 along the longitudinal extension of the longitudinal supporting members 13 can be constituted for example by a plurality of connecting regions which are mutually spaced along the longitudinal extension of the longitudinal supporting members 13 and which can be selectively engaged with by the anchoring brackets 14 by virtue of mutual joining means.

In greater detail, such connection regions are constituted for example by a plurality of fixing openings 21, which are mutually spaced and are defined along the longitudinal extension of each longitudinal supporting member 13.

At least one connecting bolt 22 can be inserted in each one of the fixing openings 21 and can engage with a locking nut 22a in order to provide the link between a respective anchoring bracket 14 and the corresponding longitudinal supporting member 13.

Preferably, the fixing openings 21 have an elongated shape along the extension of the longitudinal supporting members 13, so as to allow a certain degree of adjustment of the position of the anchoring brackets 14 along their longitudinal extension as well. Conveniently, the fixing openings 21 can be defined at least at a lateral wing 13b of the longitudinal supporting members 13 which is designed to be directed toward the roof 6 of the building. More preferably, both lateral wings 13b of the longitudinal supporting members 13 have a respective plurality of fixing openings 21, so that the longitudinal supporting members 13 can be connected to the anchoring brackets indifferently by means of one or the other of the lateral wings 13b.

In particular, on the abutment plate 17 of the anchoring brackets 14 it is advantageously possible to define a folded connecting portion 23, which is designed to be arranged substantially parallel to the slope 5 of the roof 6 and is fixed to the corresponding longitudinal supporting member 13 by virtue of the fixing openings 21 and by virtue of a respective connecting bolt 22.

More particularly, in the folded connecting portion 23 there is at least one linking hole 24, in which a connection bolt 22 is inserted which in turn is engaged in a fixing opening 21, which is selected so as to fix the corresponding anchoring bracket 14 to the corresponding longitudinal supporting member 13.

Optionally, in the folded connecting portion 23 it is also possible to define a plurality of joining holes 24, which are arranged so as to be mutually aligned, along an adjustment direction, and can be engaged selectively by means of a connecting bolt 22, which in turn is engaged in the selected fixing opening 21, so as to be able to vary the distance between the locking means 15 associated with the corresponding anchoring bracket 14 and the point where that anchoring bracket 14 is connected to the corresponding longitudinal supporting member 13.

It should be noted that with this structure it is possible to vary the angular orientation of the abutment plates 17 and therefore of the anchoring brackets 14 with respect to the corresponding longitudinal supporting member 13, about an axis that is defined by the connecting bolt 22, so as to offer the possibility of orientating, according to requirements, the anchoring brackets 14 with respect to the longitudinal supporting members 13, before proceeding to fasten the connecting bolt 22 by means of its locking nut 22a.

Conveniently, at least one of the anchoring brackets 14 can be provided with an annular safety region 14a, which can be defined for example on the abutment plate 17 or more specifically on the corresponding folded connecting portion 23 and acts as an engagement region for the spring clips which are provided on the safety harnesses that must be worn by the user before accessing the roof 6 in order to perform maintenance of the device according to the invention or manually move the covering element 2 from the position for use to the non-use position or vice versa.

Advantageously, in order to meet the most disparate requirements of application, the device according to the invention is furthermore provided with adjustment means that make it possible to modify the relative position between the or between each plate-like protection element 7 and the anchoring means 11.

Conveniently, such adjustment means comprise means for varying the position of the or of each plate-like protection element 7 along the longitudinal extension of the longitudinal supporting members 13.

In particular, such means for varying the position of the or of each plate-like protection element 7 along the longitudinal extension of the longitudinal supporting members 13 comprise for example a plurality of abutment regions, which are mutually spaced, along the longitudinal extension of each longitudinal supporting member 13 and which can be engaged with selectively by the interconnection means 12, so as to make it possible to arrange the or each plate-like protection element 7 in the most suitable position with respect to the door or window closure element 4.

Conveniently, such abutment regions are constituted by a plurality of linking openings 25, which are mutually spaced and defined along the longitudinal extension of the longitudinal supporting members 13, preferably at the central wall 13a of the longitudinal supporting members 13.

In particular, in the linking openings 25 of each of the longitudinal supporting members 13 it is possible to accommodate at least one connecting pin 26, which can be constituted for example by a linking dowel, by a threaded element or by another similar element, and which makes it possible to link the interconnection means 12 to the corresponding longitudinal supporting member 13.

Preferably, the linking openings 25 have an elongated shape along the longitudinal extension of the corresponding longitudinal supporting member 13, so as to make it possible to adjust the position of the connecting pin 26 within each one of them.

Conveniently, the interconnection means 12 can comprise hinge means 27, which are arranged substantially at one end of the or of each plate-like protection element 7 and make it possible to rotate the or each plate-like protection element 7 about an axis that is substantially parallel to the positioning axis 10.

In particular, the hinge means 27 are constituted by a first hinge element 27a, which is fixed preferably to the perimetric supporting frame 9 of the corresponding plate-like protection element 7, and by a second hinge element 27b, which is connected to the first hinge element 27a by virtue of a rotation pivot 27c and which in turn can be connected to a corresponding longitudinal supporting member 13 preferably by means of a respective connection pin 26, which is inserted in a selected linking opening 25. More preferably, multiple, mutually spaced hinge means 27 can be provided along one end side of the plate-like protection element 7.

At the end of each plate-like protection element 7 that lies opposite to the end provided with the hinge means 27, the interconnection means 12 can comprise means 28 for the detachable coupling of the plate-like protection element 7 to the anchoring means 11.

In particular, these detachable coupling means 28 can be activated in order to keep the corresponding plate-like protection element 7 in the active position, and can be deactivated when it is instead desired to move the plate-like protection element 7 to the inactive position by means of its rotation about the hinge means 27.

For example, the detachable coupling means 28 are constituted by a respective coupling element 28a, which is fixed to the perimetric supporting frame 9 of the corresponding plate-like protection element 7, and by a linking element 28b, which can be detachably connected to the coupling element 28a, by means of a detachable connection pin 28c, and which in turn can be coupled to a corresponding longitudinal supporting member 13 by virtue of a corresponding connecting pin 26, which is engaged in a selected linking opening 25.

It is optionally possible to provide that the coupling element 28a can rotate with respect to the connecting element 28b about the detachable connecting pin 28c, so that the detachable coupling means 28 can also act as a hinge for the corresponding plate-like protection element 7 and, at the same time, it is possible to provide that the rotation pivot 27c of the hinge means 27 can be removed, so that the hinge means 27 can also perform a function of detachable connection between the corresponding plate-like protection element 7 and the anchoring means 11.

For example, the hinge means 27 can connect the corresponding plate-like protection element 7 to one of the longitudinal supporting members 13, and in this case the detachable coupling means 28 allow the linking of the plate-like protection element 7 to the other longitudinal supporting member 13, such as for example in FIG. 1.

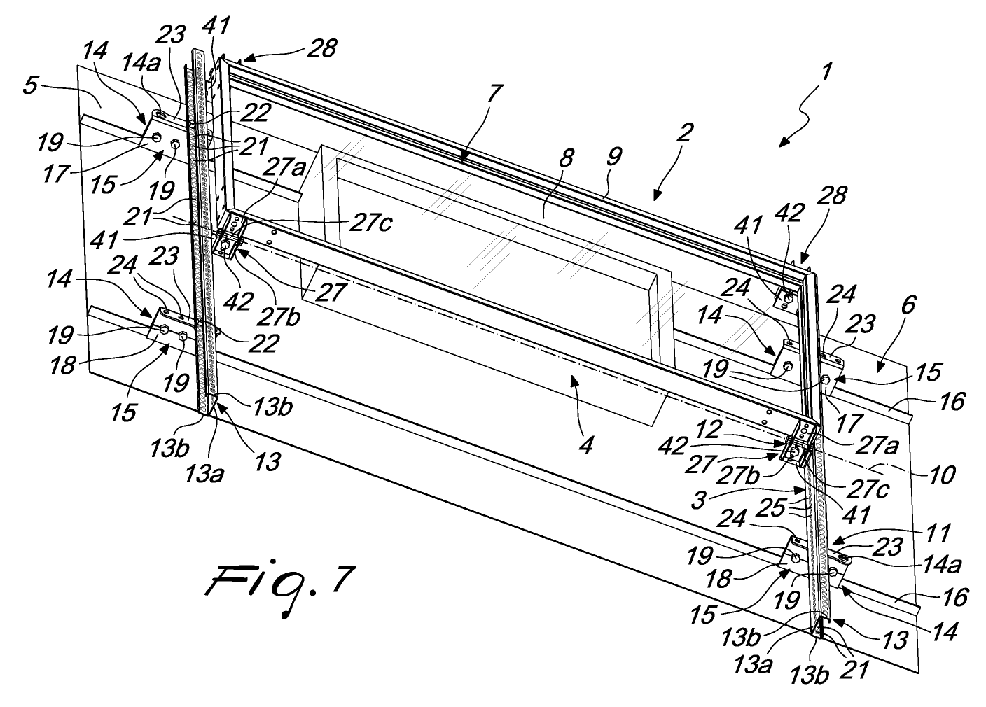

As an alternative, each of the hinge means 27 can be connected to a respective longitudinal supporting member 13, and likewise each of the detachable coupling means 28 allows the linking of the plate-like protection element 7 to a corresponding longitudinal supporting member 13, as in the examples of FIGS. 7 and 9.

In this case, the hinge means 27, as well as the detachable coupling means 28, can conveniently be connected to the respective longitudinal supporting members 13 by virtue of respective connecting elements 41, which are L-shaped and can be connected, with one of their portions, to the hinge means 27 and to the detachable coupling means 28, by virtue of respective joining bolts 42 and, with another of their portions, to the longitudinal supporting members 13 by virtue of respective connecting pins 26.

Optionally, the interconnection means 12 can comprise at least one supporting arm 29, which is connected, at one of its longitudinal ends, to an end of a corresponding plate-like protection element 7 and can be coupled, at its opposite longitudinal end, to the anchoring means 11.

In practice this supporting arm 29 makes it possible to keep at least one portion of the corresponding plate-like supporting element 7 distanced above the anchoring means 11 and therefore also above the door or window closure element 4, particularly when the plate-like supporting element 7 is in the active condition.

Advantageously, it is possible to provide at least two supporting arms 29 which are connected, at one of their ends, to a same end of the plate-like protection element 7 and, at their other end, to the anchoring means 11.

Conveniently, it is possible to provide, at the end of the plate-like protection element 7 that lies opposite to the end which is connected to the supporting arms 29, angular connection means 30, which make it possible to connect the plate-like protection element 7 to the anchoring means 11 so that the plate-like protection element 7 is kept inclined with respect to the plane of arrangement of the seat of the window.

In particular, the angular connection means 30 can conveniently have a structure that is similar to the hinge means 27 or to the detachable coupling means 28, both described above.

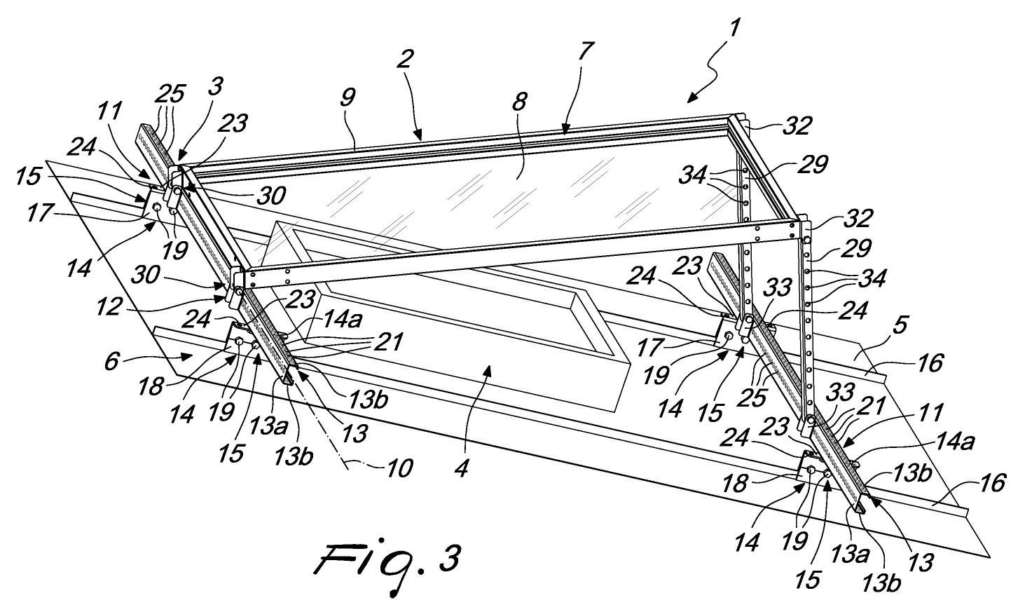

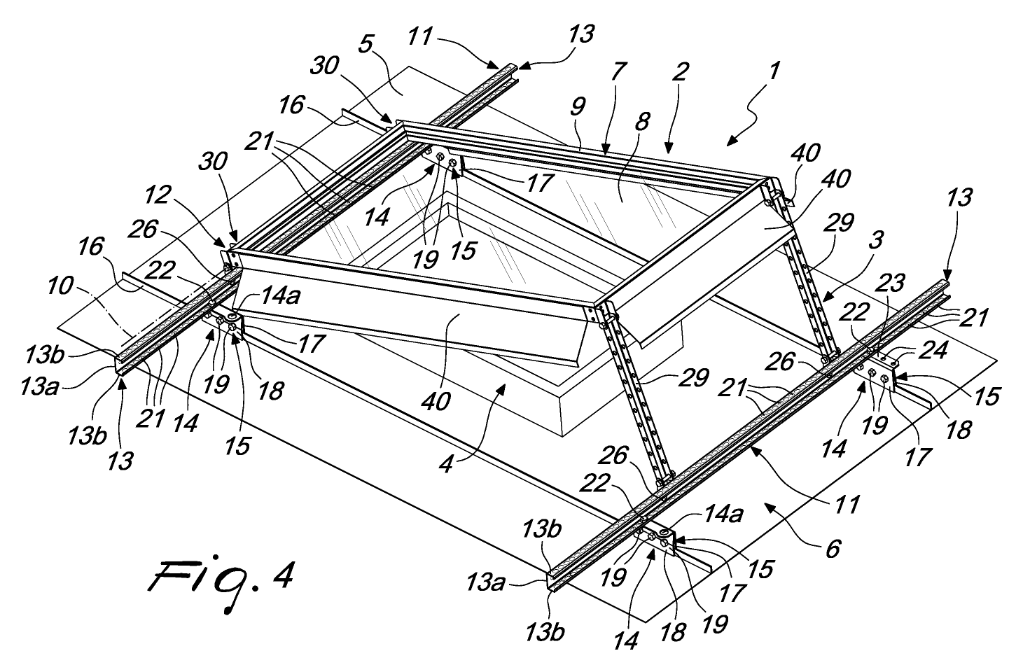

In this case, the supporting arms 29 are conveniently articulated, by means of a first hinge 32 which is arranged at one of their longitudinal ends, to the corresponding plate-like protection element 7 and, by means of a second hinge 33 which is arranged at their opposite longitudinal end, to one of the longitudinal supporting members 13, as shown in the examples of FIGS. 3 and 5 or, optionally, to a respective longitudinal supporting member 13, as in the example of FIG. 8.

Also in this case, the supporting arms 29 advantageously have means for modifying the inclination of the corresponding plate-like protection element 7, which comprise for example a plurality of connection seats 34, which are mutually spaced and arranged along the longitudinal extension of the supporting arms 29 and can be engaged with selectively by the first hinge 32 and/or by the second hinge 33, so as to be able to vary the point of connection between the plate-like protection element 7 and the supporting arms 29 and/or between the supporting arms 29 and the longitudinal supporting members 13, as a consequence modifying the inclination of the plate-like protection element 7 with respect to the plane of arrangement of the seat of the door or window closure element 4. Optionally, such means for modifying the inclination of the plate-like protection element 7 can also be obtained by providing the supporting arms 29 with a telescopic structure, so that they can be extended or retracted according to requirements.

As an alternative, as in the example of FIG. 6, the supporting arms 29 can optionally have the function of keeping the corresponding plate-like protection element 7, in the active condition, distanced from and substantially parallel to the plane of arrangement of the seat of the door or window closure element 4.

In this case, at the end of the plate-like protection element 7 that lies opposite to the one which is connected to the supporting arms 29, it is possible conveniently to provide auxiliary supporting arms 35, which are connected to the anchoring means 11 and make it possible to ensure an optimum support of the plate-like protection element 7 in a position that is substantially parallel to the plane of arrangement of the seat of the door or window closure element 4.

In particular, the auxiliary supporting arms 35 can be connected to the other longitudinal supporting member 12 with respect to the one that is connected to the supporting arms 29, as in the example of FIG. 6, or, as an alternative, to a respective longitudinal supporting member 13.

Also in this case, the supporting arms 29 can each be constituted by at least two branches 29a and 29b, which are mutually hinged, at one of their longitudinal ends, about a pivoting axis 36, which is substantially parallel to the slope 5 of the roof 6.

More specifically, there is a first branch 29a, which is connected, at its opposite longitudinal end, to a longitudinal supporting member 13 by virtue of a connecting pin 26 which is inserted in a selected linking opening 25, and a second branch 29b, which is connected, at its opposite longitudinal end, to the plate-like protection element 7, for example by virtue of a hinge connection 37.

With this structure, the supporting arms 29 are adapted to pass from an extended condition, in which the two branches 29a and 29b are substantially mutually aligned and in which the plate-like protection element 7 is in the active condition, to a folded condition, in which the two branches 29a and 29b are substantially mutually parallel and side-by-side, below their pivoting axis 36, and in which the plate-like protection element 7 is in the inactive condition, and vice versa.

Conveniently, the auxiliary supporting arms 35 can be connected, at one of their ends, to one of the longitudinal supporting members 13 or to a respective longitudinal supporting member 13 by virtue of detachable connection means, which are constituted for example by respective locking stems 37 that can be detachably inserted in corresponding engagement holes 38 which are formed within the auxiliary supporting arms 35, and are articulated, at their opposite end, to the plate-like protection element 7, so that they can be turned over onto the plate-like protection element 7 when the plate-like protection element 7 is moved into the inactive condition.

Advantageously, along the auxiliary supporting arms 35, it is possible to provide a plurality of engagement holes 38, which are mutually spaced and designed to be engaged with selectively by means of a locking stem 37, so as to be able to arrange the plate-like protection element 7 with various different inclinations with respect to the plane of arrangement of the seat of the door or window closure element 4.

With reference to FIG. 2, if the covering element 2 comprises a first plate-like protection element 7a and a second plate-like protection element 7b which can be positioned at an angle with respect to each other, then it is conveniently possible to provide the first plate-like protection element 7a and the second plate-like protection element 7b so that they are mutually pivoted, at one of their ends, about a folding axis 39 which is substantially parallel to the slope 5 of the roof 6.

In this case, the first plate-like protection element 7a can be connected rotatably, at its opposite end, to the anchoring means 11, about a rotation axis which is substantially parallel to the folding axis 39, for example by virtue of hinge means 27.

The second plate-like protection element 7b can instead be detachably connected, at its opposite end, to the anchoring means 11, for example by virtue of detachable coupling means 28.

With this structure, with the covering element 2 in its position for use, the first plate-like protection element 7a and the second plate-like protection element 7b can be arranged so as to be mutually angularly spaced, about the folding axis 38, and inclined with respect to the plane of arrangement of the seat of the door or window closure element 4, whereas, with the covering element 2 in the non-use position, the first plate-like protection element 7a and the second plate-like protection element 7b can be moved into a condition in which they face toward each other and are arranged substantially parallel to the slope 5 of the roof 6.

It should be added that it is optionally possible to apply, to the peripheral region of the plate-like protection element 7, extension elements 40, which are made for example of plastic material and make it possible to increase the surface covered by the plate-like protection elements 7, for example if the dimensions of the door or window closure element 4 to be protected are greater than the dimensions available for the plate-like protection elements 7.

Moving on to describe in greater detail some practical examples of embodiment of the device according to the invention, with reference to the embodiment shown in FIG. 1, it can be seen that the covering element 2 has a single plate-like protection element 7 which is arranged substantially parallel to the slope 5 of the roof 6 and is connected, at one end, to one of the longitudinal supporting members 13 by virtue of hinge means 27 and to the other of the longitudinal supporting members 13 by virtue of removable coupling means 28.

It can furthermore be seen that the longitudinal supporting members 13 are arranged so that one is in proximity to the upper end of the door or window closure element 4 and the other is in proximity to the lower end of the door or window closure element 4.

In this case, the position of the plate-like protection element 7 can be adjusted along the longitudinal extension of the longitudinal supporting members 13, depending on the position in which the door or window closure element 4 is arranged with respect to the linking elements to which the anchoring brackets 14 are locked, by connecting the hinge means 27 and the detachable coupling means 28 to different linking openings 25.

FIG. 3 shows an embodiment in which the covering element 2 is constituted by a single plate-like protection element 7, which is inclined with respect to the plane of arrangement of the seat of the door or window closure element 4, by virtue of a pair of supporting arms 29, which are articulated, with one of their ends, by means of a first hinge 32, to one end of the plate-like protection element 7 and, with their opposite end, to a same longitudinal supporting member 13 which is located in proximity to the lower end of the door or window closure element 4, by means of a second hinge 33.

At its end that lies opposite to the end connected to the supporting arms 29, the plate-like protection element 7 is connected, by virtue of angular connection means 30, to the other longitudinal supporting member 13, which in turn is positioned in proximity to the lower end of the door or window closure element 4.

FIG. 8 is a view of an alternative embodiment in which the supporting arms 29, which keep the plate-like protection element 7 inclined, in the active condition, are connected by means of a second hinge 33 to a respective longitudinal supporting member 13, which can be positioned in proximity to a corresponding end of the door or window closure element 4.

In particular, the second hinges 33 of the supporting arms 29 in this case are connected to the respective longitudinal supporting members 13, for example by virtue of the interposition of respective connecting elements 41, which are substantially L-shaped and have a first portion, which is connected to the corresponding second hinge 33 by means of a joining bolt 42, and a second portion, which is substantially perpendicular to the first portion and is connected to the corresponding longitudinal supporting member 13 by virtue of a linking pin 26 which is inserted in a selected linking opening 25.

Also in this case, the end of the plate-like protection element 7 that lies opposite to the end connected to the supporting arms 29 is connected, by virtue of angular connection means 30, to both longitudinal supporting members 13, for example by virtue of respective connecting elements 41.

In FIG. 9 an embodiment can be seen in which the covering element 2 comprises at least two plate-like protection elements 7 and specifically a first plate-like protection element 7a and a second plate-like protection element 7b, which in the active condition are arranged mutually side-by-side and substantially parallel to the plane of arrangement of the seat of the door or window closure element 4.

In particular, with their contiguous end, the first plate-like protection element 7a and the second plate-like protection element 7b are connected to the longitudinal supporting members 13 by virtue of detachable coupling means 28, whereas at their opposite end they are connected to the longitudinal supporting members 13 by virtue of hinge means 27, so that they can be turned over, by virtue of rotations in mutually opposite directions, about the corresponding positioning axis 10 that is defined by the hinge means 27, in order to arrange them, in the inactive condition, substantially parallel to the slope 5.

Also as shown in FIG. 9, the hinge means 27 of the first and second plate-like elements 7a and 7b are each connected to a respective longitudinal supporting member 13 by virtue of for example respective connecting elements 41, which are connected to the second hinge elements 27b by virtue of respective joining bolts 42 and to the longitudinal supporting members by virtue of respective connecting pins 26.

FIG. 2 shows an embodiment of the invention in which the covering element 2 comprises a first plate-like protection element 7a and a second plate-like protection element 7b, which in the active condition are mutually inclined and are inclined with respect to the plane of arrangement of the seat of the door or window closure element 4.

As can also be seen in FIG. 2, the longitudinal supporting members 13 can be arranged in proximity to the upper and lower end of the door or window closure element 4 and the first plate-like protection element 7a can be hinged to the second plate-like protection element 7b, about a folding axis 39, and to one of the longitudinal supporting members 13, by virtue of hinge means 27. The second plate-like protection element 7b is instead connected, at its end that lies opposite to the end connected to the first plate-like protection element 7a, to the other longitudinal supporting member 13 by virtue of detachable coupling means 28.

In this way, in the non-use position, the first and second plate-like protection elements 7a and 7b can be closed against each other along one edge, like a book, by virtue of a relative rotation thereof about the folding axis 39, and they can be turned over onto the roof 6 of the building by virtue of a rotation of the first plate-like protection element 7a about the hinge means 27.

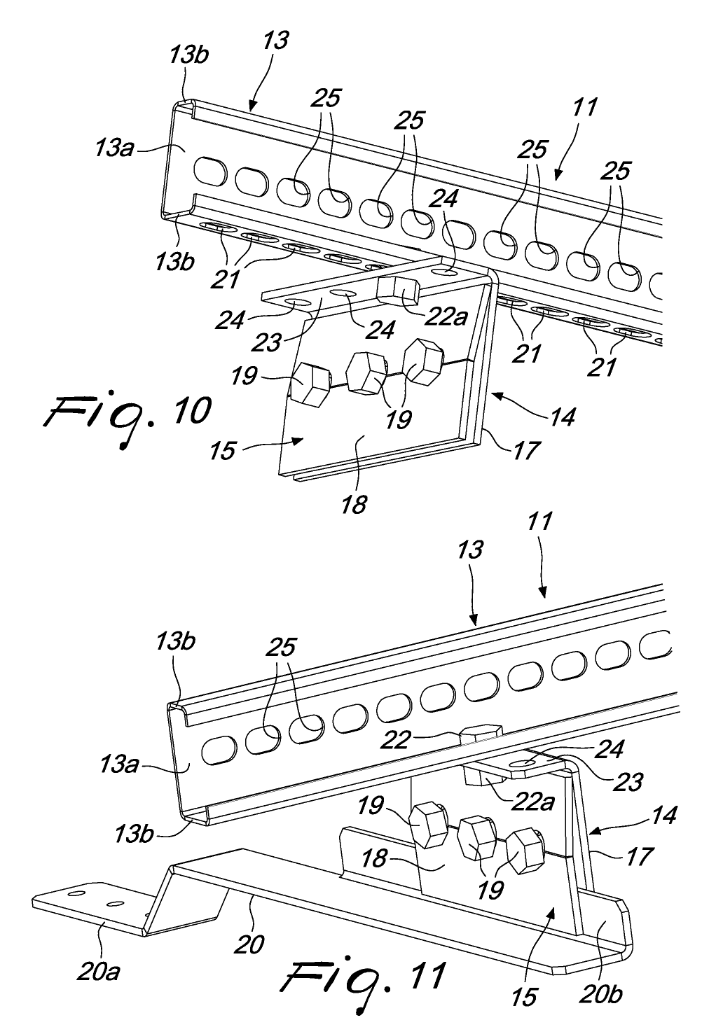

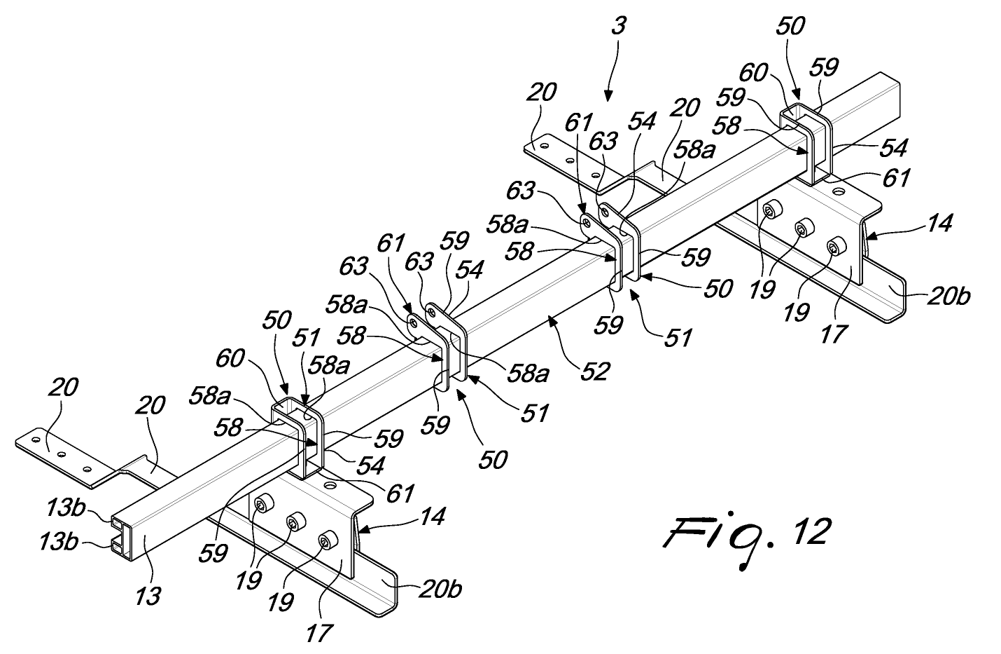

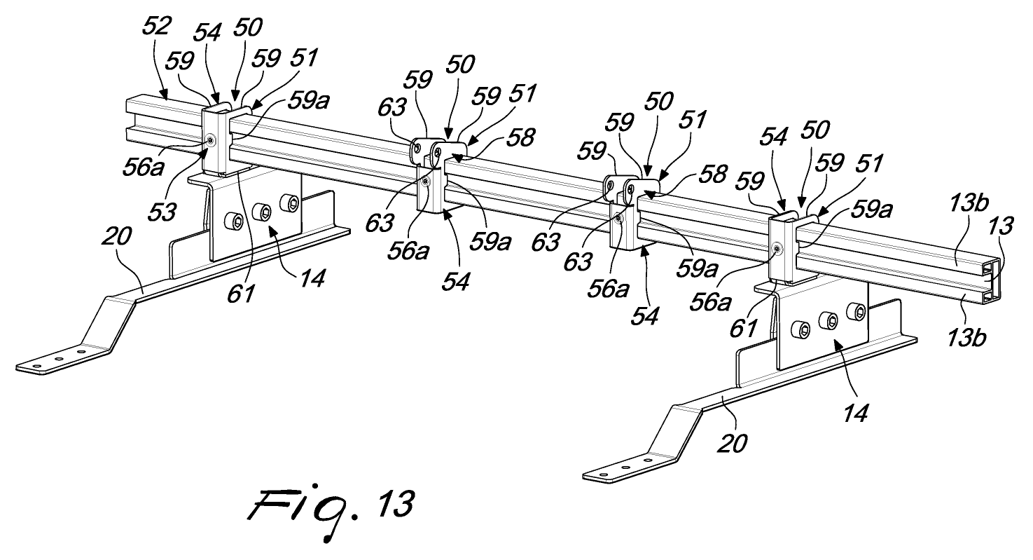

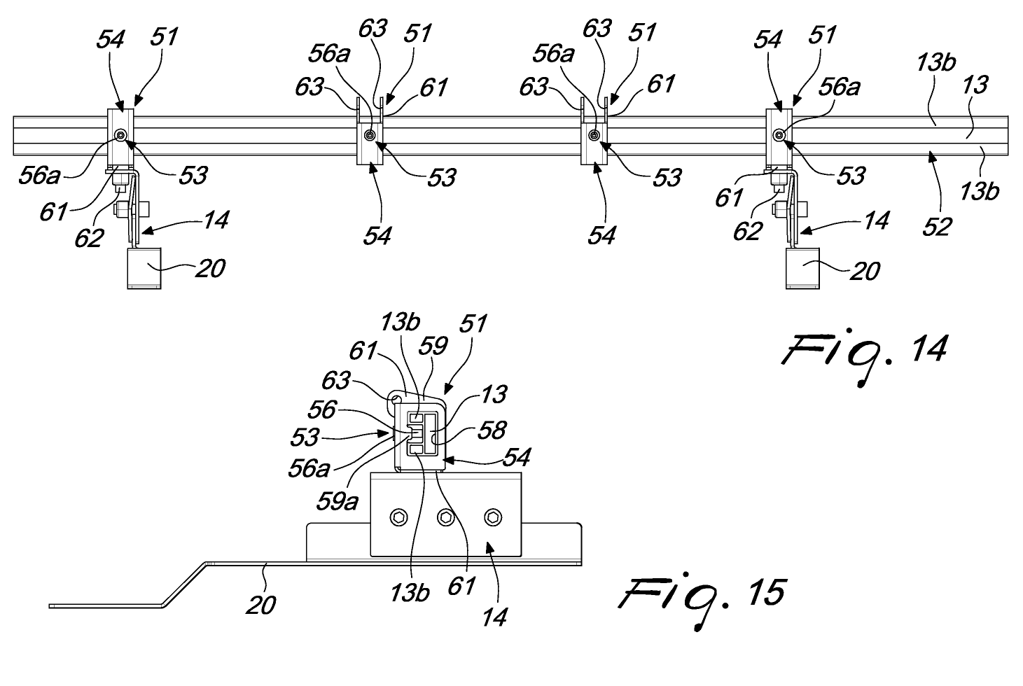

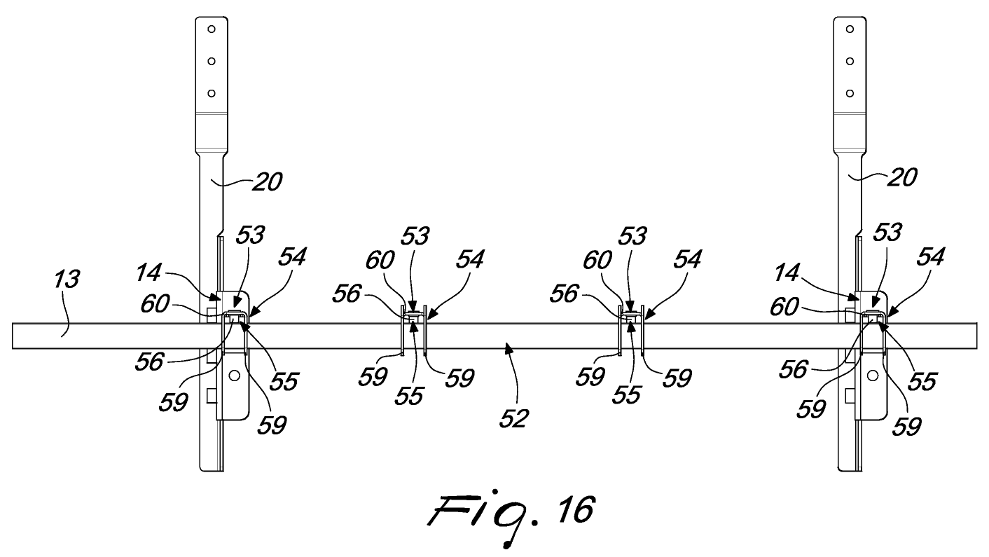

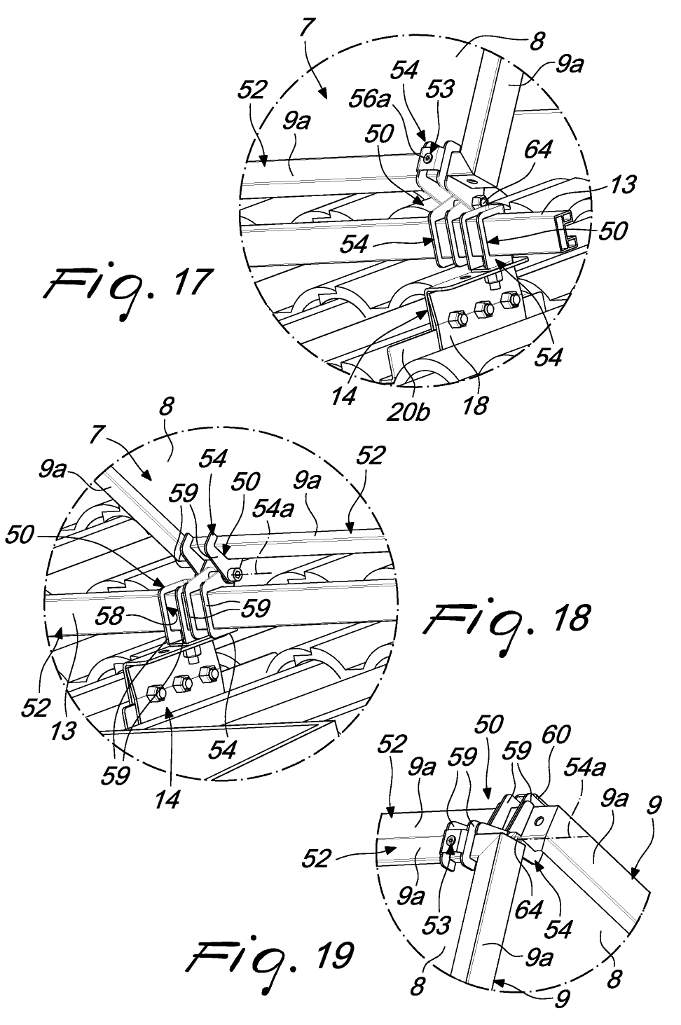

With reference to FIGS. 12 to 26, an embodiment of the connection means 3 and, in particular, of the anchoring means 11 and of the interconnection means 12 is described hereinafter which makes it possible to perform a continuous adjustment, instead of an adjustment by discrete points as in the solutions described previously, of the position of the anchoring means 11 with respect to the door or window closure element 4, and of the position of the covering element 2 with respect to the door or window closure element 4 or of one plate-like protection element 7 with respect to another one.

More specifically, this embodiment is based on the use of at least one connection device 50, which in general has slider means 51, which can slide freely along a respective elongated guiding element 52 and can be detachably locked to the elongated guiding element 52 in the desired position by virtue of presser means 53.

In greater detail, by virtue of the connection device 50 it is conveniently possible to provide the connection between an anchoring bracket 14 and a longitudinal supporting member 13 or between a longitudinal supporting member 13 and a plate-like protection element 7 or indeed between two plate-like protection elements 7.

In practice, the elongated guiding element 52 can be constituted, according to the situations, by one of the longitudinal supporting members 13 or by a profiled element 9a that constitutes the perimetric supporting frame 9 of one of the plate-like protection elements 7.

By virtue of the fact that the slider means 51 of the connection device 50 can slide freely along a longitudinal supporting member 13 or along a profiled element 9a of the perimetric supporting frame of a plate-like protection element 7, so that they can be moved into any desired position, and by virtue of the fact that the slider means 51 can be locked in the desired position, by virtue of the presser means 53, the connecting device 50 makes it possible to perform a continuous adjustment of the position of an anchoring bracket 14 along a longitudinal supporting member 13, of a plate-like protection element 7 along a longitudinal supporting member 13, or of a plate-like protection element 7 with respect to another plate-like protection element 7 which is connected thereto by virtue of the same connection device 50.

Descending into the details, the slider means 51 of each connection device 50 are constituted by at least one linking element 54, which is provided with the presser means 53 and is mounted so that it can slide on a respective elongated guiding element 52, which as previously mentioned can be one of the longitudinal supporting members 13 or one of the profiled elements 9a of the perimetric supporting frame 9 of one of the plate-like protection elements 7.

The connection device 50 can optionally also be constituted by a pair of connection elements 54, each of which can be coupled so that it can slide along a respective elongated guiding element 52 and connected to each other rotatably about a hinge axis 54a, as will be explained hereinafter.

Preferably, the presser means 53 comprise at least one fastening element 55 which can be maneuvered to act by pushing against a lateral face of the elongated guiding element 52, in order to lock the corresponding connection element 54 to the elongated guiding element 52. For example, the fastening element 55 is constituted by a threaded pin 56, which is coupled with a female thread 57 which is defined in a portion of the linking element 54, and which can be maneuvered rotationally by means of a maneuvering head 56a in order to produce an axial approaching or distancing movement, respectively toward or from the elongated guiding element 52, of its end that lies opposite to the maneuvering head 56a. The engagement of the fastening element 55 with the elongated guiding element 52 locks the linking element 54 to the elongated guiding element 52.

Conveniently, each linking element 54 defines in general an engagement seat 58, which is designed to be crossed by the elongated guiding element 52 upon which the linking element 54 is mounted.

More specifically, each linking element 54 is constituted for example by a pair of plate-like elements 59, which are arranged on planes which are parallel to each other and perpendicular to the longitudinal axis of the elongated guiding element 52 and can be mutually and integrally connected to each other by virtue of a linking block 60 which supports the presser means 53 and more specifically defines the female thread 57. Conveniently, the plate-like elements 59 are crossed by a respective passage opening 58a, which provides the engagement seat 58.

With specific reference to the Figures from 12 to 16, if the elongated guiding element 52 is constituted by one of the longitudinal supporting members 13, then the engagement seat 55 of each linking element 54 is crossed by the longitudinal supporting member 13 upon which the linking element 54 is mounted.

In particular, the engagement seat 58 has a shape that corresponds substantially to the transverse cross-section 1 of the longitudinal supporting member 13.

As shown, the longitudinal supporting member 13 can have, as in the preceding solutions, a substantially C-shaped transverse cross-section, with a pair of lateral wings, between which a protrusion 59a is inserted which is defined by each plate-like element 59, in order to ensure greater stability of the connection between the linking element 54 and the longitudinal supporting member 13.

In this case, the plate-like elements 59 of the linking element 54 conveniently constitute a closed ring around the respective passage opening 58a, so as to be able in practice to laterally surround the longitudinal supporting member 13.

As shown, each linking element 54 mounted on the longitudinal supporting member 13 is provided with a connecting portion 61 for its connection to an anchoring bracket 14 or to another linking element 54 which is associated with a plate-like protection element 7.

In particular, if the linking element 54 is designed to be associated with one of the anchoring brackets 14, then the connecting portion 61 conveniently comprises a strip which mutually joins the plate-like elements 59 of the linking element 54 and is crossed by an accommodation hole for a bolt 62, which allows the mutual joining of the linking element 54 and the anchoring bracket 14, in a manner similar to the connecting bolt 22 of the preceding solutions.

If the linking element 54 mounted on the longitudinal supporting member 13 is instead designed to be connected to another linking element 54 which is associated with a plate-like protection element 7, then the connecting portion 61 is advantageously constituted by a pair of eyelets 63, which are defined on the plate-like elements 59 and are designed to accommodate a pivot 64, which is substantially parallel to the longitudinal supporting member 13, in order to connect, rotatably about the axis of the pivot 64, the linking element 54 mounted on the longitudinal supporting member 13 to the linking element 54 which is associated with the plate-like protection element 7.

The pivot 64 in practice defines the hinge axis 54a and conveniently can be locked in an axial direction by a nut 64a, which is screwed onto a threaded end of the pivot 64, and by a head 64b, which is arranged at the opposite end of the pivot 64.

With reference in particular to FIGS. 20 and 21, if the elongated guiding element 52 upon which the linking element 54 is mounted is constituted by one of the profiled elements 9a that constitutes the perimetric supporting frame 9 of the plate-like protection elements 7, then the plate-like elements 59 of the linking element 54 can conveniently have the shape of an open ring, in which there is a slot 65 for the passage of the panel 8 of the plate-like protection element 7.

In this case too, the linking element 54 is provided with a connecting portion 61, which conveniently comprises a pair of through holes 61 a for accommodating the pivot 64, which allows its connection to a linking element mounted upon the longitudinal supporting member 13.

Advantageously, as mentioned previously, the connection device 50 can also be used to mutually connect two plate-like protection elements 7.

As can be seen in FIG. 19, the connection device 50 in this case is conveniently constituted by two linking elements 54, which are each associated with a respective plate-like protection element 7 and are mutually connected by means of a pivot 64, so as to allow the possibility of varying the angle between the two plate-like protection elements 7. More specifically, each of the two linking elements 54 has, in this case, a shape that corresponds substantially to the one shown in FIGS. 20 and 21, so that each of them can be mounted so that it can slide along the profiled element 9a of the perimetric supporting frame 9 of the corresponding plate-like protection element 7 that is directed toward the other plate-like protection element 7.

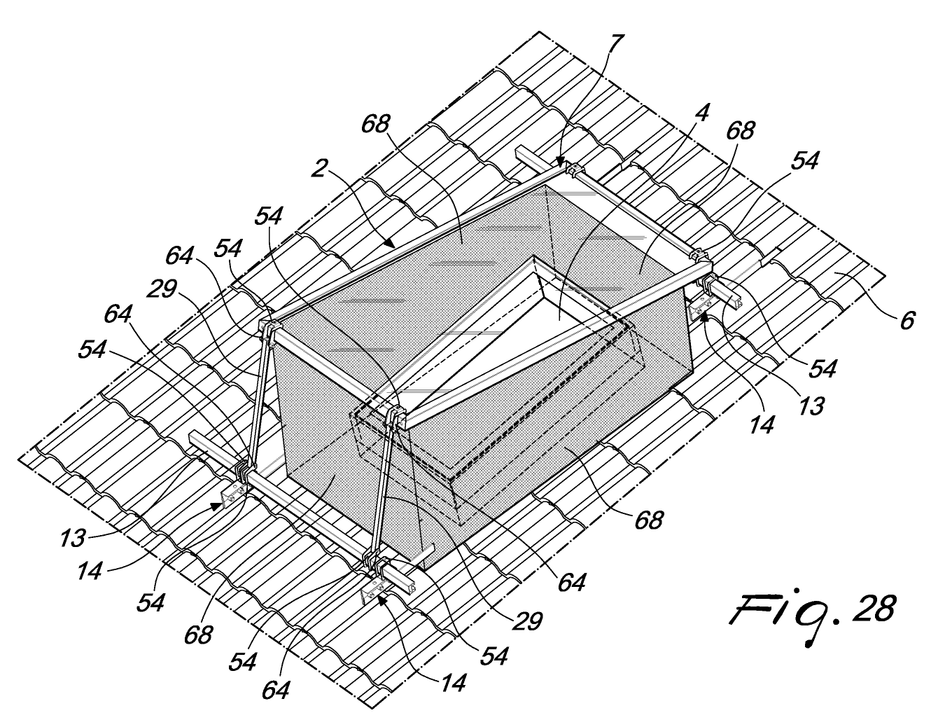

It should be noted that a linking element 54 that is mounted upon one of the longitudinal supporting members 13 can be connected to another linking element 54, which is instead mounted on one of the profiled elements 9a that constitutes the perimetric frame 9 for supporting a plate-like protection element 7, also but not exclusively by means of the interposition of a supporting arm 29, which is articulated, at its opposite ends, to the two linking elements 54, by virtue of respective pivots 64, as shown in the example of FIG. 28.

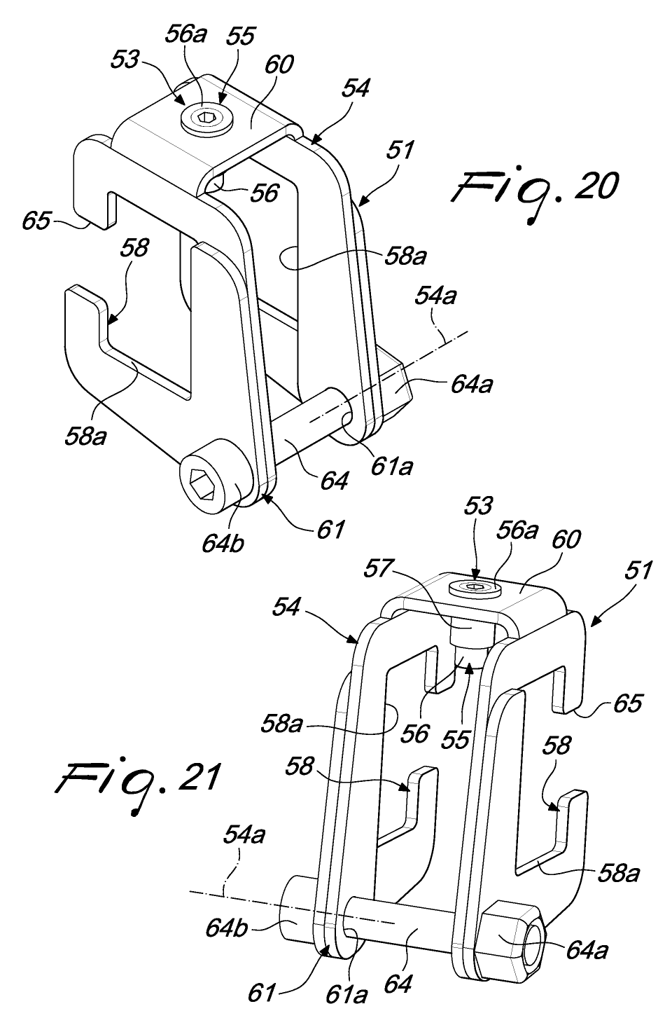

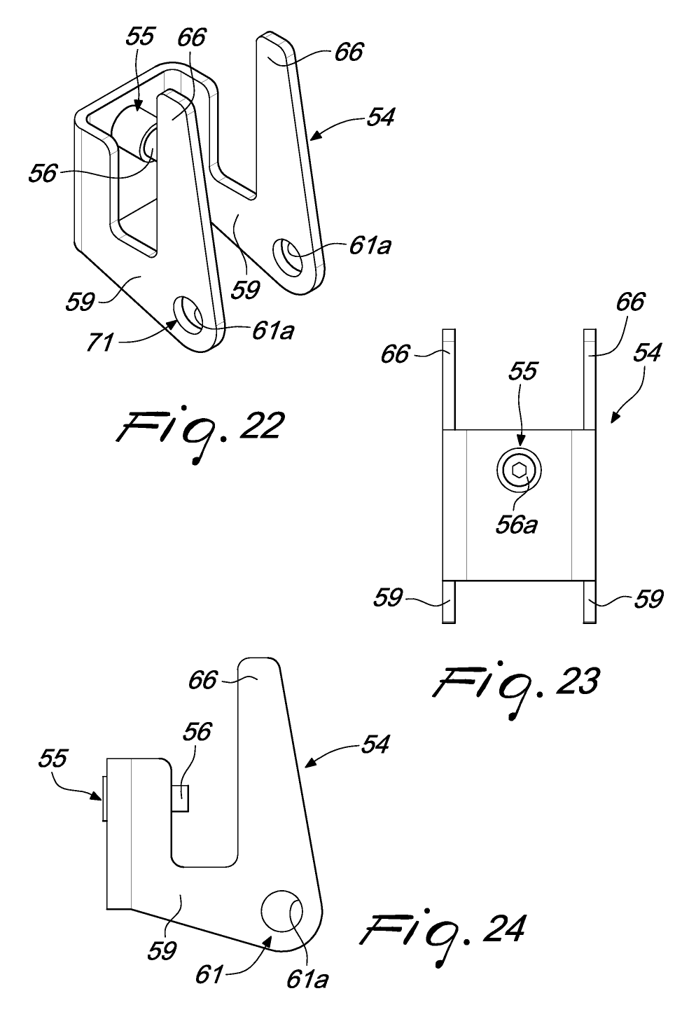

FIGS. 22 to 24 and FIGS. 25 and 26 show an embodiment of the linking element 54 that is designed to be applied to a plate-like protection element 7, which, instead of being provided by a panel 8 and by a perimetric supporting frame 9, as in the previous examples, is entirely provided by means of a metal plate 70, which is folded at its edges, in order to define perimetric borders 71, along at least one of which one or more linking elements 54 can be associated.

As can be seen in particular in FIG. 22, in this case the plate-like elements 59 in practice define two abutment branches 66, upon which the outer side 71 a of the perimetric border 71 of the metal plate 70 that constitutes the plate-like protection element 7 can rest.

The fastening element 55 associated with the linking element 54 acts instead against the inner side 71 b of the perimetric border 71.

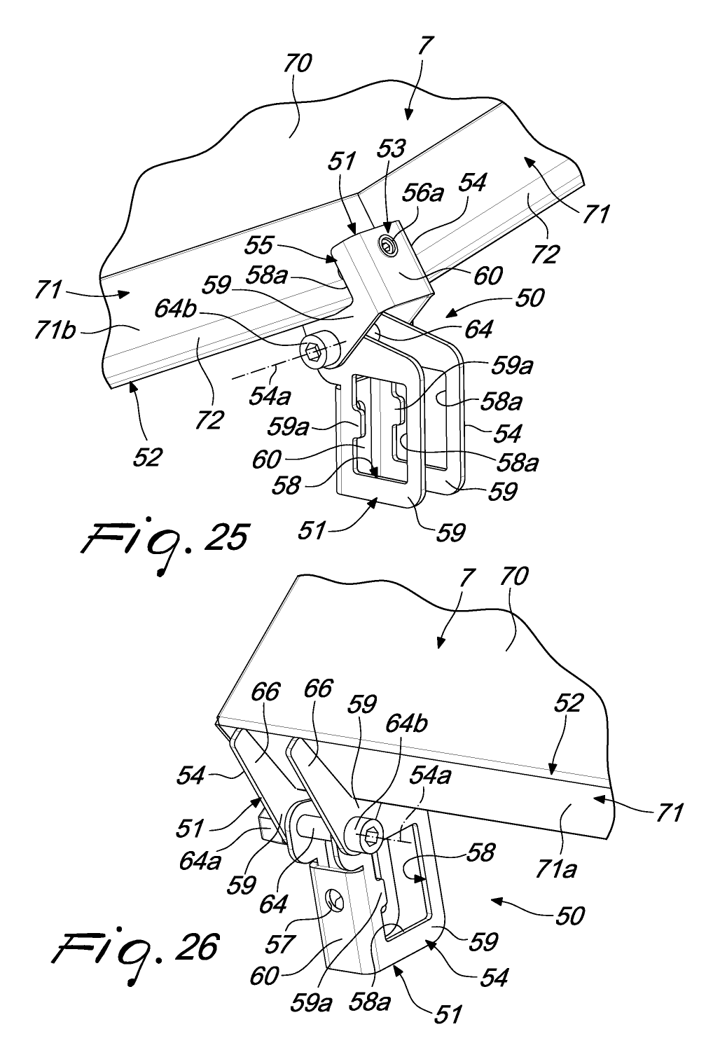

As can be seen in FIG. 25, the fastening element 55 makes it possible, also in this case, conveniently, to also lock the linking element 54 to an extraction from the perimetric border 71 of the metal plate 70 with which it is coupled, along a direction that is perpendicular to the longitudinal extension of the perimetric border 71, by virtue of the engagement of the threaded pivot 56 against a raised rib 72 that is provided along the free edges of the perimetric borders 71 and which is also defined by means of a fold of the metal plate 70.

It should be noted that the possibility of freely moving each connection device 50 along the longitudinal supporting member 13 and along a profiled element 9a of the plate-like protection element 7 and the possibility of locking it in any desired position also makes it possible to correctly position, in any situation, the linking points between plate-like protection element 7 and longitudinal supporting member 13 or between two plate-like protection elements 7.

Moreover, the use of various connection devices 50 in order to provide the connection between the anchoring brackets 14 and the longitudinal supporting members 13, between the plate-like protection elements 7 and the longitudinal supporting members 13 and between two plate-like protection elements 7 also has the considerable advantage of making the assembly and installation of the device according to the invention on roofs extremely simple and quick.

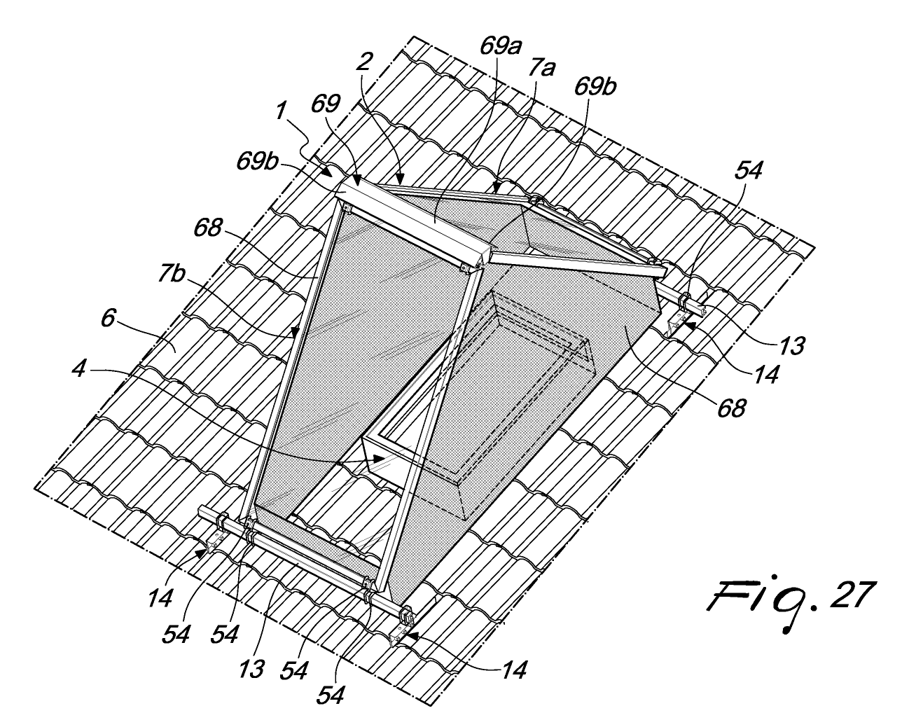

For the sake of completeness, with reference to FIGS. 27 and 28, it should be added that at least one insect- and/or pollen-blocking sheet 68 can be associated with the covering element 2 and is constituted for example by a net or the like, which is conveniently anchored to the edges of the covering element 2 and more specifically to the edges of the plate-like protection element or elements 7 that constitute the covering element 2, and is made to descend onto the roof 6 of the building, where it is coupled by virtue of adapted fixing means, such as screws or other means, so as to prevent unwanted insects and/or allergy-inducing pollens or any dust that may be present in the air from reaching the door or window closure element 4 from the regions located laterally to the covering element 2, without preventing the passage of light.

Advantageously, as shown in FIG. 27, if the covering element 2 comprises a first plate-like protection element 7a and a second plate-like protection element 7b which are mutually inclined, then it is also possible to mount, between the first and second plate-like protection elements 7a, 7b, an intermediate covering element 69, which is made for example of sheet metal and conveniently has a central portion 69a and a pair of mutually opposite wings 69b, which are inclined so as to form slopes, so as to cover the gap that is present between the first and second plate-like protection elements 7a and 7b.

The operation of the device according to the invention is evident from the foregoing description and in particular the fact is stressed that the covering element 2, when it is in the condition for use, makes it possible to effectively shelter windows or access trapdoors of the roof against atmospheric precipitation in general and against snow in particular.

Moreover, the device according to the invention, by virtue of the insect- and/or pollen-blocking sheet 68, also makes it possible, once installed, to prevent insects, such as mosquitoes or flies, or pollen from entering the building through the door or window closure element 4, without obstructing the passage of light.

In practice it has been found that the invention is capable of fully achieving the intended aim and in particular the fact is stressed that the covering element 2 allows the passage of light and air through the windows of the roof even in the event of heavy snowfall.

Moreover, it should be stressed that the device according to the invention can be applied to any type of cover, for example made of sheet metal, tiles and so forth, with multiple adjustments for its ideal positioning.

All the characteristics of the invention which are indicated above as advantageous, convenient or the like may also be omitted or be replaced with equivalent characteristics.

The individual characteristics presented with reference to general teachings or specific embodiments may all be present in other embodiments or may replace characteristics in these embodiments.

The invention thus conceived is susceptible of numerous modifications and variations, all of which are within the scope of the appended claims.

In practice, the materials used, so long as they are compatible with the specific use, as well as the contingent shapes and dimensions, may be any according to requirements and to the state of the art.

All the details may moreover be replaced with other, technically equivalent elements.

The disclosures in Italian Patent Applications No. VR2009A000187 and No. VR2010A000118 from which this application claims priority are incorporated herein by reference.

Where technical features mentioned in any claim are followed by reference signs, those reference signs have been included for the sole purpose of increasing the intelligibility of the claims and accordingly such reference signs do not have any limiting effect on the interpretation of each element identified by way of example by such reference signs.

1-17. (canceled)

18. A device for protecting door or window closure elements for roofs or the like against atmospheric precipitation, comprising at least one covering element, which can be connected to the structure of a building by virtue of connection means and can be arranged in at least one position for use, in which, at least partially, it is arranged above and faces at least one door or window closure element that is formed substantially parallel to a portion of the cover of the building.

19. The device according to claim 18, wherein said cover portion is constituted by a slope of the roof of the building.

20. The device according to claim 18, wherein said at least one position for use said at least one covering element is at least partially distanced upward from said at least one door or window closure element.

21. The device according to claim 19, wherein said at least one covering element comprises at least one plate-like protection element.

22. The device according to claim 21, wherein said at least one plate-like protection element has at least one portion that is substantially transparent to light.

23. The device according to claim 21, wherein, with said at least one covering element in said at least one position for use, said at least one plate-like protection element is arranged at an angle with respect to a plane of arrangement of a seat of said at least one door or window closure element.

24. The device according to claim 21, wherein, with said at least one covering element in said at least one position for use, said at least one plate-like protection element is arranged substantially parallel to a plane of arrangement of a seat of said at least one door or window closure element.

25. The device according to claim 18, wherein said at least one covering element comprises at least two plate-like protection elements, respectively at least one first plate-like protection element and at least one second plate-like protection element; with said at least one covering element in said at least one position for use, said first plate-like protection element and said second plate-like protection element being arranged at an angle with respect to each other and being inclined with respect to a plane of arrangement of a seat of said at least one door or window closure element.

26. The device according to claim 18, wherein said at least one covering element is adapted to pass from said at least one position for use to a non-use position, in which it is arranged laterally with respect to said at least one door or window closure element, and vice versa.

27. The device according to claim 21, wherein, with said at least one covering element in said at least one position for use, said at least one plate-like protection element is in an active condition, in which it faces toward and is arranged above, with at least one portion of one of its faces, said at least one door or window closure element; said at least one plate-like protection element being arranged, with said at least one covering element in said non-use position, in an inactive condition, in which it is arranged substantially parallel to said slope of the roof and laterally with respect to said at least one door or window closure element.

28. The device according to claim 21, wherein said at least one plate-like protection element can rotate on command with respect to said slope of the roof, about a positioning axis which is substantially parallel to said slope of the roof, in order to pass from said active condition to said inactive condition, and vice versa.

29. The device according to claim 21, wherein said connection means comprise means for anchoring to said portion of cover of the building and means for interconnection between said anchoring means and said at least one plate-like protection element.

30. The device according to claim 29, further comprising means for adjusting the position of said at least one plate-like protection element with respect to said anchoring means.

31. The device according to claim 21, further comprising means for heating said at least one plate-like protection element.

32. The device according to claim 18, wherein said connection means comprise at least one connection device, which is provided with slider means, which can slide freely along a respective elongated guiding element and can be removably locked to said elongated guiding element, in the desired position, by virtue of presser means.

33. The device according to claim 32, wherein said elongated guiding element comprises a longitudinal supporting member or a profiled element which constitutes a perimetric frame for supporting said at least one plate-like protection element, said slider means being constituted by at least one connecting element, which can be coupled to a corresponding elongated guiding element so that it can slide, said presser means comprising at least one fastening element which is adapted to act by pushing against a lateral face of said elongated guiding element.

34. The device according to claim 18, wherein at least one insect- and/or pollen-blocking sheet can be associated with said at least one covering element.
